(19) United States
(12) Patent Application Publication
(10) Pub. No.: US 2010/0228640 A1
(43) Pub. Date: Sep. 9, 2010

(54) Systems and Methods for Providing Responses to Requests from Users of an Entertainment System

(76) Inventors: Andrew T. Anderson, LOS GATOS, CA (US); Vinod Viswanathan, CUPERTINO, CA (US); Milan Karangutkar, SANTA CLARA, CA (US)

Correspondence Address: CARR & FERRELL LLP, 2200 GENG ROAD, PALO ALTO, CA, 94303, US

(21) Appl. No.: 12/397,035

(22) Filed: Mar. 3, 2009

(51) Int. Cl. G06Q 30/00; G06F 21/00; H04L 9/32; G06Q 20/00; G06Q 50/00

(52) U.S. Cl. 705/26; 726/4; 713/171; 705/40

(57) ABSTRACT

Systems and methods for providing a response to a request are provided. A request may be a transaction request. In some embodiments, a request is received from a client device which is coupled to a display device. The client device is associated to a user. A determination is made whether the request is authorized. A request may be authorized if it includes a key that is associated with sensitive credit card user data stored offsite by a merchant bank. A request is transmitted to a server coupled to the display device. A response from the server is transmitted to the display device for display therein. The response is based on the determination of whether the request is authorized.

### CROSS-REFERENCE TO RELATED APPLICATIONS

This application is related to U.S. nonprovisional patent application Ser. No. 12/396,866, titled “Systems and Methods for Interactively Rewarding Users of an Entertainment System” and filed on Mar. 3, 2009, the disclosure of which is incorporated herein by reference.

### SUMMARY OF THE INVENTION

Systems and methods for providing responses to requests made by users are described herein. A request may be a request for a transaction. A transaction may be a currency-based transaction, a transaction involving a quantity of credit tokens, and any combination thereof. A transaction may include a purchase of a good, a service or any combination thereof. The systems and methods provided herein allow for requests to be fulfilled in a secure manner by utilizing offsite card data storage, such that sensitive credit card or payment instrument information (e.g., credit card information or banking account information) is not transmitted along with the requests. By storing the user data offsite and providing a key that is associated with the user data for an authorized request, the technology discussed herein allows for quick fulfillment of the authorized request in a secure, reliable manner.

In a first aspect, a computer implemented method for providing a response to a request is provided. A request is received from a client device which is coupled to a display device. The client device is associated to a user. A determination is made whether the request is authorized. A request is transmitted to a server coupled to the display device. A response from the server is transmitted for display on the display device. The response is based on the determination of whether the request is authorized.

In a second aspect, a computer readable storage medium having stored thereon a program executable by a processor to perform a method for providing a response to a request is provided. A request is received from a client device which is coupled to a display device. The client device is associated to a user. A determination is made whether the request is authorized. A request is transmitted to a server coupled to the display device. A response from the server is transmitted for display on the display device. The response is based on the determination of whether the request is authorized.

In a third aspect, a computer implemented method for providing a response to a request is provided. A request is received from a client device which is coupled to a display device. The client device is associated to a user. A key is generated if the request is authorized. The key is associated user data stored offsite by a data storage. The request is associated with the key if the request is authorized. A determination is made whether the request includes the key. The request is transmitted a server coupled to the display device. A response from the server is transmitted for display on the display device. The response is based on the determination on whether the request includes the key.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an exemplary system for providing an entertainment service to a user.

FIG. 2 is a block diagram of an exemplary system for providing a response to a request from a user.

FIG. 3 is a flow chart of an exemplary method for providing a response to a request from a user.

FIG. 4 is a flow chart of an exemplary method for providing a response based on a key for an authorized request by a user.

FIG. 5 is a flow chart of a further exemplary method for providing a response to a request from a user.

### DETAILED DESCRIPTION OF THE INVENTION

Systems and methods are provided herein for providing responses to user requests. In some embodiments, an electronic payment and commerce system is set forth for purchasing digital goods and physical products through a client device coupled to a display device. Such a system supports digital transactions in a secure manner, by allowing for offsite sensitive payment instrument user data storage. Offsite sensitive payment instrument user data storage may include offsite card data storage, such as storage of a user's credit card information. By allowing for user data to be stored offsite, a user may make one or more requests online through a client device without having to worry about security issues regarding transmissions of sensitive user data (e.g., financial and or transactional information of a user, credit card data, banking account data, social security identification, and the like).

Also, the user may make a real-time request for content purchase without interfering with a session that is already being displayed on the user's display device. The request may occur seamlessly for the user's experience. Finally, the systems and methods described herein allow for both pre-pay and post-pay methodologies to be utilized. In other words, the user may be charged after the user has received a fulfillment of a request (e.g., a request for digital content). Further details regarding post-pay methodologies will be provided later herein.

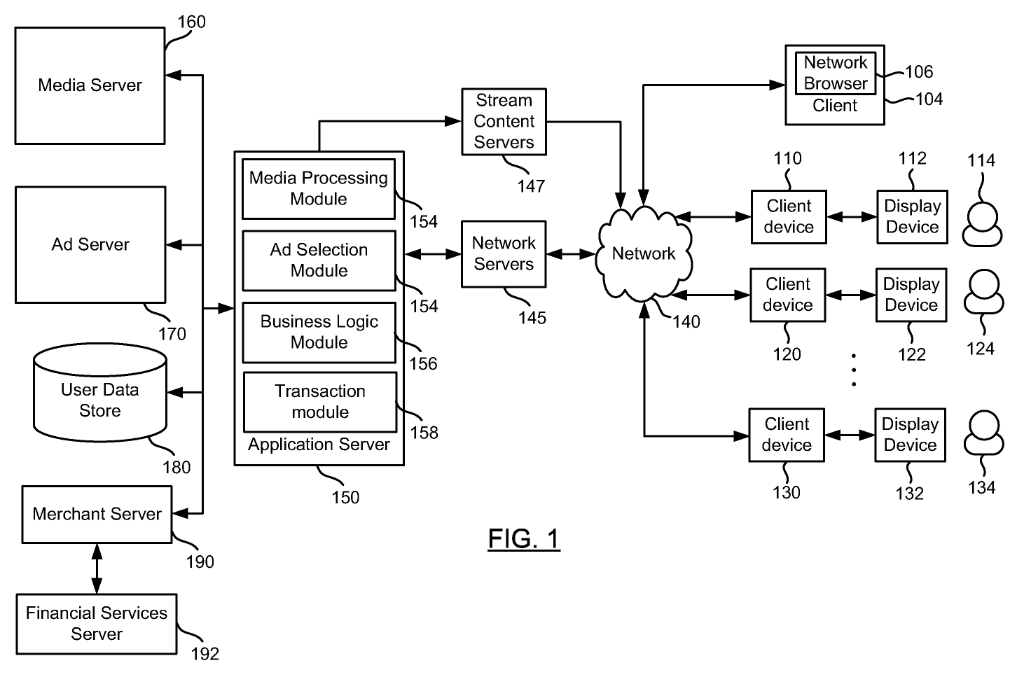

The systems and methods described herein can best be understood in the context of an entertainment service that may be used by a user. FIG. 1 is a block diagram of an exemplary system for providing such an entertainment service to the user. The system of FIG. 1 includes a system of servers in communication with a system of client devices over a network. Client devices 110, 120 and 130 communicate with display devices 112, 122 and 132, respectively. Users 114, 124 and 134 are associated with each display device and client device combination, respectively. For example, a user 114 may provide input to client device 110 to retrieve and playback video content through display device 112. In some embodiments, the media service discussed herein is implemented by application server 150 and network server 145. In some embodiments, the system providing media service can also include any of servers 160-190.

Client 104 is coupled to network 140 and may include network browser 106. Network browser 106 may request, receive and provide network content such as a web page or other multimedia page. For example, a user may access a media service provided over network 140 through network browser application 106.

Client devices 110-130 and client 104 are coupled to network 140. In some embodiments, each of client devices 110-130 may be implemented as a set-top box or multimedia device which provides content through a viewer user interface. An exemplary set-top box is disclosed in U.S. patent application Ser. No. 12/360,007, entitled “Set-Top Box,” filed on Jan. 26, 2009, the disclosure of which is incorporated herein by reference. Other devices may embed the technology directly, including but not limited to television sets, mobile devices, gaming consoles, watches, phones, and digital cameras.

Network 140 can facilitate communication between network server 145, client 104 and client devices 110-130. Network 140 may be implemented as the Internet or other WAN, a LAN, intranet, extranet, private network or a combination of networks. The system uses the public internet in a managed or unmanaged host environment to transmit the multimedia content. The system provides a robust method for issuing free replays of the multimedia content in case of a transmission failure on the public internet.

Network server 145 can include one or more servers and communicates with application server 150 and network 140. Network server 145 can be implemented as a web server that operates as an intermediary server between application server 150 and network 140. For example, network server 145 may be a web server or application web server that receives requests from client devices 104, 110, 120 and 130, processes and forwards the requests to application server 150, and sends a response generated by application server 150 to the requesting client device.

Application server 150 communicates with network server 145, can include one or more servers, and includes logic which implements the media service of the present technology. Application server 150 can include media processing module 152, ad selection module 154, business logic module 156 and transaction module 158. Each of the modules 152-158 can be implemented on a different application server or backend server, such as servers 160-190. Other modules and logic may be incorporated on application server in addition to those illustrated in FIG. 1.

Media processing module 152 may receive, encode, and transmit video, audio, images and other media to client devices 104 and 110-130 through network server 145. The media may be transmitted as a complete file, a streaming data such as streaming video, or in some other format. Media processing module 152 may incorporate selected advertisements received from or identified by ad selection module 154 within video media and transmit the video media with the incorporated ads.

Ad selection module 154 may access advertisement media and advertisement parameters from ad server 170. The ad parameters specify how ads can be incorporated into a particular media file by media processing module 152. The parameters can indicate a user gender, geographic location, income level, marriage status, or other user demographic data, as well as user viewing behavior, purchase behavior, and other user data, or the ad may be selected directly by the user. The ad parameters may also specify content categories, brand adjacency, frequency requirements, cost information, and other display rules for providing the ad to a user.

Business logic module 156 may handle various business logic and processing rules associated with the media service. For example, business logic module 156 may handle user loyalty and reward programs which reward a user for certain viewing behavior and interaction with advertisements. Business logic module 156 may also retrieve and manage user data contained in user data store 180 and determine revenue distribution among different participants in a media service ecosystem, such as users, advertisers, content providers, merchants, network service provider companies (cable companies, power companies, telephone companies, and so forth), and other groups.

Transaction module 158 may facilitate commerce transactions between a client device and merchant server 190. Facilitating a purchase transaction allows a user to purchase goods or service associated with an advertisement through the media service.

Application server 150 may transmit content through stream content servers 147. In some embodiments, stream content servers 147 may include one or more servers configured to stream content to several client devices. For example, stream content servers 147 may include a host stream device which receives media and advertising content. The host stream device may provide content to one or more streaming servers which establish connections with a client device and stream media content, including requested and recommended media as well as advertisements, to the client.

Application server 150 may communicate with media server 160, ad server 170, user data store 180, and merchant server 190. Media server 160 may store media 162 and related information, including metadata 164 for stored media, which may be retrieved by application server 150. Media 162 may comprise movies, TV episodes, offers, product or service information, and other video, as well as audio and image media, interactive media and application services such as two-way Voice Over Internet Protocol (VOIP) telephony, two-way video and other interactive applications. Media metadata 164 may include information associated with each piece of media or an offer, such as a media category (i.e., sports, documentary, family, and so forth), media length, potential breaks within the media for inserting ads, cost of playback for media, and other data associated with the media.

Ad server 170 can communicate with application server 150 and may include one or more advertisements 172 as well as advertisement parameters 174 associated with each ad. Advertisements 172 may be associated with a company, product, service or some other topic of potential interest for a user. The ad parameters indicate to whom a particular ad should or is required to be provided to, as well as cost information, timing information and other ad requirements. Ad parameters may be configured for an advertisement by an advertiser with preferred and required parameters for matching an ad to a combination of a user data (including user demographic data), media content, and time.

User data store 180 can communicate with application server 150 and data for users having an account with the media service. The user data can include user demographic data, user playback data, user purchase data, and other data associated with a user of the media service. Merchant server 190 handles purchases requested by a user through client device 130. Merchant server 190 may be associated with an e-commerce service, a particular service or product provider, or some other organization. Merchant server 190 may communicate with one or more banks or credit card, credit card processing services, merchant gift cards, pre-paid merchant cards, electronic payment systems such as PayPal or other financial services as represented by financial server 192.

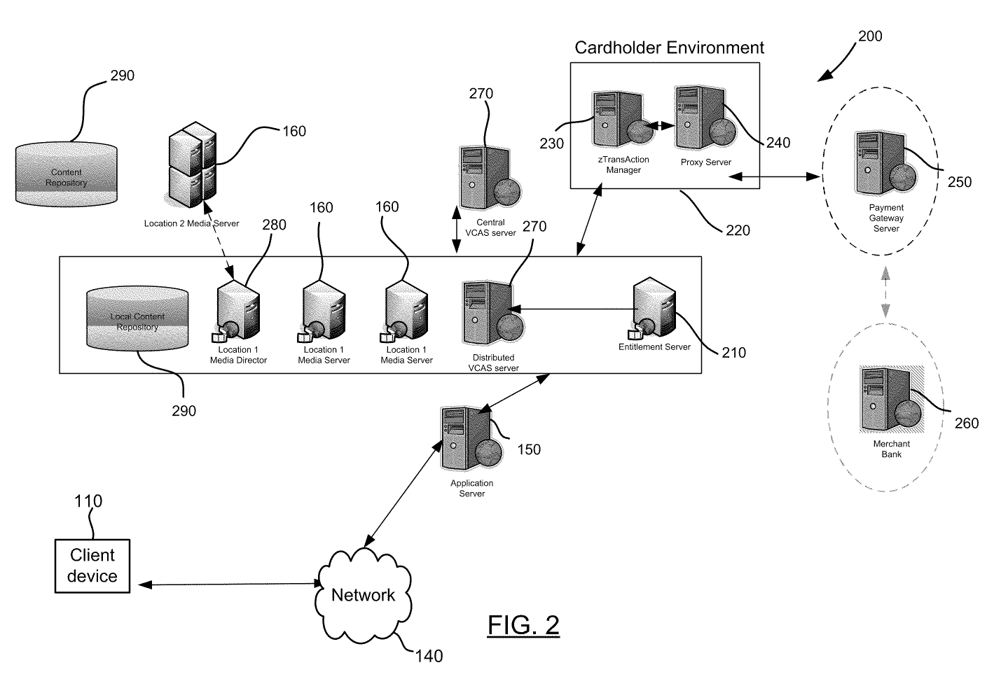

FIG. 2 is a block diagram of a system 200 for providing a response to a request made by a user. Like numbered elements refer to like elements. For instance, the client device 110 and the network 140 described in relation to FIG. 1 are also shown in FIG. 2. Furthermore, as with all the figures included herein, FIG. 2 is exemplary only. One skilled in the art will appreciate that the specific number, arrangement and/or layout of the elements provided in the figures is exemplary only, and the technology described herein is not restricted by what is shown in the figures. For instance, although FIG. 2 shows one payment gateway server, it will be understood by one skilled in the art that more than one payment gateway server may be present within the system 200.

The system 200 is configured to transmit secure, protected transactions on client devices (e.g., television sets and the like), with several layers of security. Security layers include dual-authentication, tokenization of credentials, secure cardholder environment, offsite storage of sensitive user data (e.g., credit card information of a user), and SSL. The system 200 may be configured such that requests (e.g., content requests and/or transaction requests) may be transmitted in the midst of a user watching video content (e.g., ads and/or programs). The system may pause the content that the user is watching during the transaction and request processes. When the processes are completed, then playback of the video content may resume depending on user interactions, preferences and system settings

The system 200 allows for users to utilize currency, a quantity of credit tokens (such as ZillionDollars), and any combination thereof, in order to purchase a product or service through a client device coupled to a display device (such as a television set). Exemplary credit tokens are described in the U.S. nonprovisional patent application Ser. No. 12/396,866, filed Mar. 3, 2009, the disclosure of which is incorporated herein by reference.

In some embodiments, the system 200 includes the client device 110, the network 140, the application server 150, a plurality of media servers 160, an entitlement server 210, a cardholder environment 220 (which may include a transaction manager 230 and a proxy server 240), a payment gateway server 250, a merchant bank 260, and a plurality of video content authority servers (VCAS servers) 270. The video content authority servers 270 are configured to authorize the streaming of video content upon receipt of the encryption key.

The system 200 may also include a media director 280 and one or more content repositories 290. The one or more content repositories 290 are configured to store content. Descriptions of the client device 110, the network 140, the application server 150, and the plurality of media servers 160 have been previously provided herein. One skilled in the art will recognize that one or more of the system components illustrated in FIG. 2 may be duplicated, combined or removed, without departing from the spirit of the technology described herein.

Using the client device 110, a user (such as user 114 of FIG. 1) can select and request any content, product or service for sale. Generally, the content that is for sale is shown to the user via the display device (such as the display device 112 of FIG. 1). The user can select the content by doing any number of user inputs, such as pressing a “BUY NOW” button on the client device 110 when the content is already selected, or highlighting the content sought and/or double clicking on the content for selection. The user may select content while watching a program or a video on the display device.

The request of the user is transmitted via the network 140 to the application server 150. The application server 150 may transmit the request of the user to the entitlement server 210. The entitlement server 210 is configured to hold the policies that regulate the availability of content that is requested by the user. Meanwhile, a transaction request (which may be separate or included with the request by the user for content) is sent to a cardholder environment 220 for further processing. The cardholder environment 220 may also include the transaction manager 230 and the proxy server 240.

In some embodiments, the transaction manager 230 transmits the transaction request to the payment gateway server 250 either asynchronously or synchronously from delivering content depending on business rules, content entitlement policies, user preferences or behavior. The transaction manager 230 may be configured to communicate with the proxy server 240. The transaction manager 230 may be viewed as a wrapper and a buffer around an initial payment gateway, and it may be configured to expand and arbitrate and normalize variant responses between multiple payment gateways. The transaction manager 230 may be configured to determine that a user has not exceeded system wide global or individual transaction thresholds. The transaction manager 230 serves as a buffer to group all transactions under a transaction threshold (such as a global max) into one sales order transaction to save on credit card banking and interchange fees. If the transaction threshold is reached, then the transaction manager may push a request (such as a CAPTURE transaction request) to the merchant bank 260 via the payment gateway server 250, in order to transfer funds to the merchant bank 260 from the credit card issuer bank for the entire transaction amount.

The transaction manager 230 may also ensure that a user is not on a credit card hold, card expired, over the credit limit. The transaction manager 230 may communicate with one or more servers (e.g., the network servers 145 and the application server 150 of FIG. 1) to transmit transaction information, such that users may view their account balance, transaction histories, and payments made through the system. The transaction manager 230 may handle currency-based transactions, transactions involving credit tokens, and any combination thereof. Through the transaction manager 230, a user may purchase a pay per view video, rent a video, own a video, or own a collection of videos indefinitely. Once they are purchased, the collection of video titles may be included in a digital media locker which may be visually shown to the user on the display device. That is, a digital media locker serves as storage to hold videos or multimedia in a user's account that the user has purchased to own. The 5-star rating is for rating how much a user LIKES the content—not whether is was delivered properly or not and has nothing to do with the T-Commerce aspects of the system. The quality of the transmission may be accepted or rejected with the ‘thumbs-down’ handler. A sales receipt is sent to the registered email address of the account holder when the sales order transaction has succeeded. Also a message is displayed on the TV screen to acknowledge the transaction displaying success or failure. On failure, the system will give the content requested anyway up to the limit of 2 times the global max (that is an adjustable setting). Uncollected transactions will be automatically retried up to the maximum number of retries allowed by the merchant bank. If the transaction is still uncollectable after charges exceed 2 times the global max, then the payment processing capabilities for the user's account are place on hold and the user is notified on the display device.

If the user wishes to use credit tokens, a separate server (not shown) provides a balance of credit tokens that the user has at his or her disposal. Credit tokens may be earned by the user if the user watches one or more commercial segments via the display device. Discussion of exemplary credit tokens and methods to earn credit tokens are described in the U.S. nonprovisional patent application Ser. No. 12/396,866, filed Mar. 3, 2009, the disclosure of which is incorporated herein by reference.

The transaction manager 230 and the proxy server 240 are both configured to securely communicate with a payment gateway server 250. The payment gateway server 250 may be coupled to a merchant bank 260, a third-party provider, or any other banking system. Upon receipt of the transaction request from the payment gateway server 250, the merchant bank 260 determines if the user is in good standing. One way to determine whether the user is in good standing is to examine records to determine whether the user's credit card account is expired or is maxed out. The merchant bank 260 may review banking account records belonging to the user, to determine if the user is in good standing with sufficient funds in their account. The merchant bank 260 may be coupled to a business account owned by the user. Utilizing banking standards and systems, the merchant bank 260 determines if the user is in good standing or has enough funds to make the transaction.

If the merchant bank 260 determines that the user is in good standing, then the merchant bank 260 will communicate this determination to the payment gateway server 250. The payment gateway server 250 in turn sends an authorization (also known as an AUTH code response) to the cardholder environment 220, indicating the request for a transaction is authorized. This places the credit card on a ‘pending’ status that reserves the funds to be captured later, thus reducing the amount of available credit by the transaction amount. The payment gateway server 250, a gateway provider (not shown), and/or the merchant bank 260 may include offsite data storage configured to store user data (e.g., credit card information, financial data, banking information of a user, and the like). Preferably, a gateway provider stores the user data externally, apart from the system 200. Preferably, the sensitive credit card user data is collected when the user joins as a subscriber or changes the payment instrument on file to the services provided by the system 200. This user sensitive credit card data may be transmitted to the merchant bank 260—for offsite card data storage—, a payment gateway server 250, and/or a gateway provider (not shown). Once the user data is received, it may stored offsite in a data storage hosted by the merchant bank. The sensitive credit card user data is replaced with a key or an alias which is associated with the user data. Then, any subsequent transactions can be processed if they reference to the key or alias, such that sensitive user data is not transmitted repeatedly for each subsequent transaction. Further, the key allows for the system 200 to enforce a spending limit on a user, if such a spending limit is pre-set. The sensitive card holder data is never transmitted to the set-top-box or multimedia device, nor to the remote control which is non-secure.

If an authorization is received by the cardholder environment 220, the authorization is transmitted to the entitlement server 210. If the entitlement server 210 receives the authorization and the key on the content to be unlocked, then the request for the content is transmitted via the application server 150 to one or more media servers 160. The identification of which of the media servers 160 provides the content to the user is based on a determination of the best path that is tailored to provide the content in an optimal delivery. If the content does not reside locally, the content is pulled by the media director 280 from a media server 160 that is external to the system 200. The encrypted content is then streamed through the network 140. An encryption key request and response is exchanged between the client device 110 and the application server 150. If the encryption key is provided, then a content key is retrieved and cached by VCAS servers 270. Once the content is decrypted, it may be watched by the user through the display device via the network 140.

In some embodiments, the system 200 also include as a merchandise mall module (not shown), which provides the user with a display of products for sale including products or services from third parties. The user may view a merchant and product catalog offers on the display device (e.g., display device 112 of FIG. 1). For example, if a user is watching a commercial, or navigating the program guide, pressing the “BUY NOW” button on a client device 110 will cause the system 200 to switch to a mode that displays the products for sale that are related to the commercial or program guide context to the user. In other words, the merchandise mall module allows for merchants (direct and third-party) to display their products to users who may become potential customers for those products. If a user purchases a product through the merchandise mall module via the system 200, a payment gateway authorizes those purchase requests that are authorized and the merchant is obligated to fulfill the transaction to complete the purchase transaction. In one embodiment, regardless of whether the merchant actually fulfills the purchase order to the user's satisfaction, the merchant is also obligated to provide referral fees or bounty funds to the service provider of the system 200 that provided the lead of potential customers for the merchant.

One skilled in the art will recognize the system 200 is configured to operate with business management software applications and/or APIs (such as APIs for an electronic payment system application web services). Also, the system 200 may be configured to operate with multiple merchant banks, payment gateways, merchandise malls, e-commerce or web stores, and/or payment gateways servers.

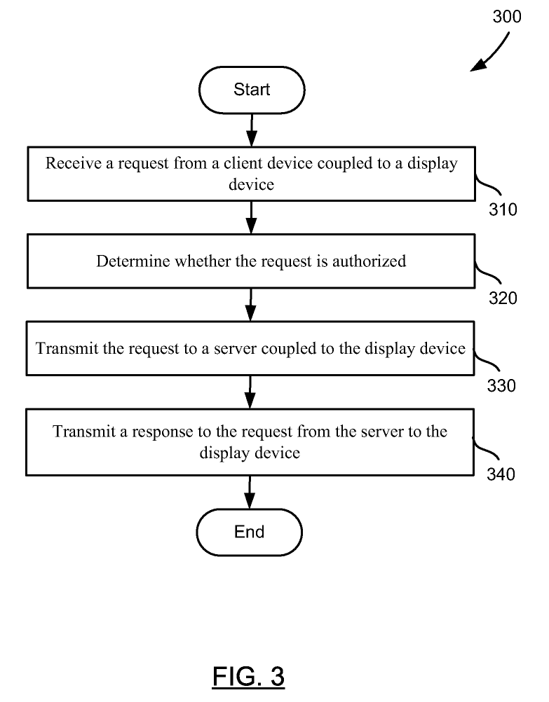

FIG. 3 provides a flow diagram of an exemplary method 300 for providing a response to a request. As with all the methods described herein, the exemplary method 300 of FIG. 3 may be accomplished the systems 100 and 200 of FIGS. 1 and 2, respectively, or a combination of the systems 100 and 200. At step 310, a request is received from a client device coupled to a display device. The client device is associated to a user. The request may be for a transaction. At step 320, a determination is made as to whether the request is authorized. At step 330, the request is transmitted to a server coupled to the display device. The server may be coupled to a payment processor. The payment processor may be configured to process payment transactions. In some embodiments, the server is coupled to a transaction manager (such as the transaction manager 230 of FIG. 2). The transaction manager may be configured to perform a currency-based transaction based on the request. Then, at step 340, a response from the server is transmitted to the display device for display therein. The response is based on the determination of whether the request is authorized.

The response may include one of a pay-per-view video, a video rental, a video purchase, a multimedia stream, a video game purchase, a multimedia replay, a multimedia clip, a video stream, a video, a video replay, a video playback, a video clip, an audio stream, an audio replay, an audio clip, and any combination thereof. In some embodiments, the response includes an acknowledgment of the request if the request is authorized. In further embodiments, the response includes a denial of the request if the request is not authorized.

The request may be for a transaction involving a quantity of credit tokens. In some embodiments, the transaction is currency-based and is related to a purchase of a good, a service, or any combination thereof.

According to various exemplary embodiments, the request includes a key if the request is authorized. The key may be associated with user data that is stored offsite by a data storage. A key may include an alias. The user data may include banking account information associated with a banking account of the user. The user data may include credit card information associated with a credit card account of the user. All subsequent transactions and/or requests for a user account will be referenced by the key, to prevent fraudulent use. A provider of the data storage for storing the sensitive credit card user data offsite may comprise a merchant bank and/or a payment gateway. In some embodiments, the sensitive credit card user data may be stored in a data storage that is associated with a system (e.g., the system 200 of FIG. 2), but remains offsite such that the user data is isolated and is not transmitted via a network of the system.

The method 300 may include further optional steps. For instance, the method 300 may include the steps of determining whether the user has reached a transaction threshold and transmitting a charge against the credit card account of the user if the transaction threshold has been reached. The primary transaction threshold may be known as a global max. The global max may be a threshold currency amount that must be reached before a sales order may be generated by the transaction manager. In other words, the system (e.g., the system 200) should batch all sales into a single sales order transaction up to the global max. If a transaction or group of transactions does not rise to the level of the global max, then the transaction or group of transactions is stored with the other transactions that are awaiting to reach the global max threshold. The global max may be considered a credit line, and users may spend up to that amount. The global max may be adjusted in real-time on a system-wide basis to adjust for prevailing business conditions. The system also supports other transaction thresholds such as an individual max which may be used to over-ride a global max setting on an individual case-by-case basis.

Another transaction threshold may be known as the global minimum. The global minimum allows for the tuning of the system for optimization based on scaling. If after a billing cycle there are not enough transactions to add up to the global minimum, then the billing may be deferred to the next cycle. The global minimum may be adjusted in real-time on a system-wide basis to adjust for prevailing business conditions.

Alternatively, the transaction threshold may be the number of transactions that the user may have prior to being charged for the transactions. Furthermore, the method 300 may include an optional step of transmitting an indicator of a media locker to the display device for display therein, the media locker representing a collection of videos that the user has purchased to own and are stored in the user's account.

The technology described herein allows for users to be charged after the request or purchase order has been fulfilled. In other words, the users are allowed to “post pay” following the fulfillment of a request or purchase order. Once the global max is reached by any request or transaction, the digital content or product will have already been delivered, so the customer is charged on his or her credit card in a post-pay type of transaction. In the case of single transactions that exceed the global max, then the system provides a pre-pay mechanism. In other words if a transaction is over the credit limit, then the system automatically switches from a post-pay mechanism to a pre-paid mechanism.

Further, the technology described herein allows for users to replay pay-per-view content at least twice if they are not satisfied for any reason. The re-play allowance may expire within a given time period, and the re-play may only apply to the title purchased.

Once the transaction threshold has been reached, a charge may be transmitted against the credit card account of the user. Alternatively, a charge against the banking account of the user may transpire. The method 300 may also include the steps of receiving an electronic transfer of currency as a result of the charge against the credit card account or the banking account of the user. In exemplary embodiments, the method 300 includes receiving a rating from the client device coupled to the display device. The rating may be associated with the response from the server as displayed on the display device. The server may include a user profile that is associated with the user. The user profile may allow for the usage of multiple credit cards or payment instruments and/or banking accounts to a given user, and thus the offsite data storage for a given user may be for such multiple accounts.

Also, the user profile may include a primary user account. The primary user account may allow a primary user (such as the head of the household) to have spending allocations for multiple sub-accounts within the primary user account for secondary users. For instance, a primary user may be a single parent with two children. The two children would be considered secondary users of the primary user account, and they may each have a sub-account to the primary user account. The single parent may choose to provide a spending allocation for each of the two children to spend utilizing the systems described herein. The single parent may also enable/disable spending, may gift dollars amounts from the primary user account to a sub-account, or may set spending limits on the sub-accounts.

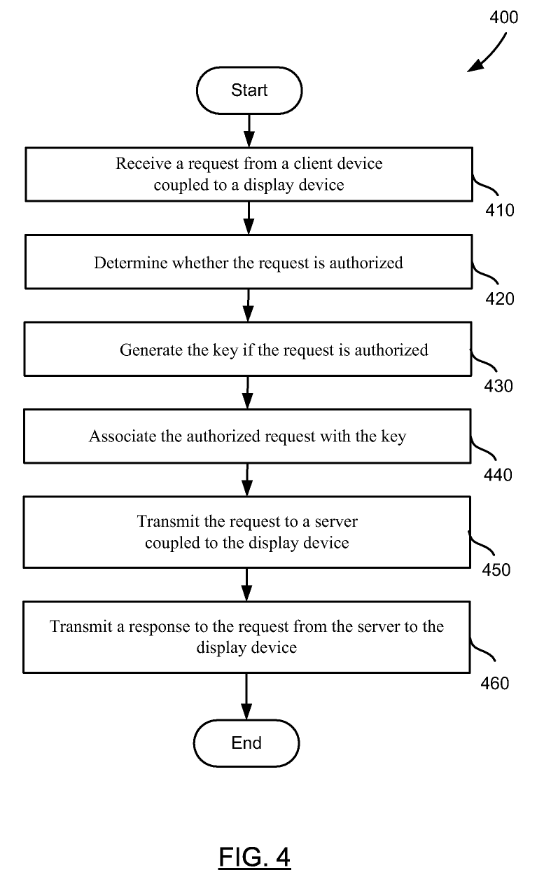

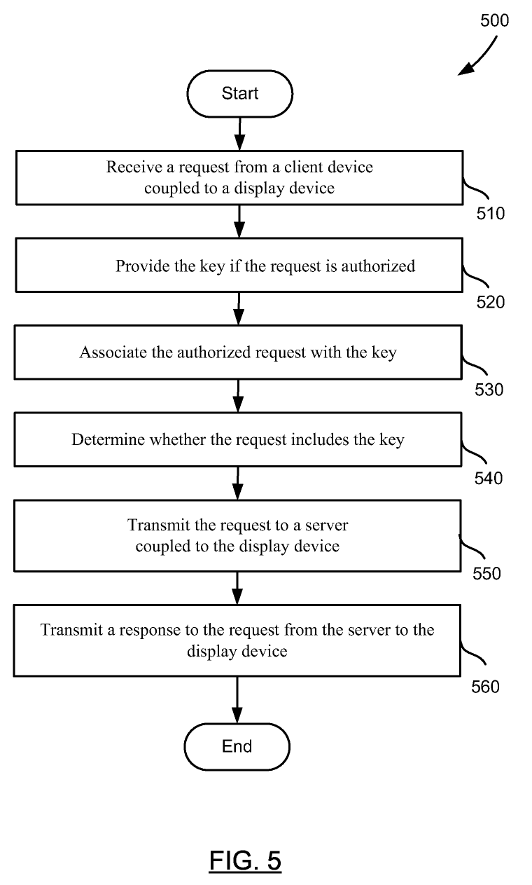

FIG. 4 is a flow chart of an exemplary method 400 for providing a response based on a key for an authorized request by a user. FIGS. 4 and 5 are somewhat similar to FIG. 3. Thus, one skilled in the art will recognize that much of the disclosure of FIG. 3 also may be applied to FIGS. 4 and 5.

Still referring to FIG. 4, at step 410, a request is received from a client device coupled to a display device. At step 420, a determination is made whether the request is authorized. At step 430, a key is generated if the request is authorized. The key may be associated with user data stored offsite. At step 440, the authorized request is associated with the key. At step 450, the request is transmitted to a server that is coupled to the display device. Finally, at step 460, a response from the server is transmitted to the display device for display therein. The response is based upon the determination of whether the request is authorized. One skilled in the art will recognize that optional steps described for FIG. 3 may also be included in the exemplary method 400 of FIG. 4.

FIG. 5 is a flow chart of a further exemplary method 500 for providing a response to a request by a user. At step 510, a request is received from a client device coupled to a display device. At step 520, a key is provided if the request is authorized. The key may be associated with user data stored offsite. At step 530, the authorized request is associated with the key. At step 540, a determination is made whether the key is included in the request. At step 550, the request is transmitted to a server that is coupled to the display device. Finally, at step 560, a response from the server is displayed on the display device. The response is based upon the determination of whether the request includes the key. One skilled in the art will recognize that optional steps described for FIG. 3 may also be included in the exemplary method 500 of FIG. 5.

A computer readable storage medium may perform one or more of the exemplary methods provided herein. One of ordinary skill will appreciate that examples of computer readable storage medium may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

In some embodiments, a user may wish to buy a pay-per-view content directly so that the user may view the content on the display device. The user may select the pay-per-view option, a “BUY NOW” button, or some other button on a client device, to indicate his selection of which content he would like to purchase. The user can then select a payment method (e.g., credit card, credit tokens, and the like) to make the purchase. An optional confirmation may appear to the user on the display device to cancel or confirm the charges. At this point, a transaction manager will process the transaction request, using the methodologies described herein. The pay-per-view video will then be played for the user on the display device. The user may rate the pay-per-view video. In some embodiments, he may press a “thumbs down” button on the client device if he is not satisfied with the quality of the video stream delivery. If the user pressed the “thumbs down” button, and if a refund limit has not been exceeded, an instant replay of the pay-per-view video may be made available to the user. Alternatively, if the user does not press the “thumbs down” button, a user will be given the option to rate the content of the video. For instance, he may rate it using 1-5 stars. Once the user has been given the opportunity to rate the content, and if he has provided his rating or he has declined to give a rating, the user is returned to the user interface of the client device. This rating is for the quality of the content—whether the user liked it or not—but is not a part of the T-Commerce process.

If the user wishes to buy a pay-per-view content using credit tokens, then the process is similar to a pay-per-view direct video purchase, except that the credit tokens are handled on a separate server to keep the interaction on the transaction manager at a minimum.

If the user wishes to purchase content to own, using a media locker, the process is similar to that of a pay-per-view direct video purchase, except that the media locker is checked to determine if the user already owns the title. If the user already owns the title, the video is played for the user. If the user does not own the video, the user is provided up to three minutes of free viewing (actual time varies by entitlement rights granted to each piece of content by the rights holders), before he must determine if he wishes to buy the video outright.

If a user wishes to pay-per-view a package (collection of movies/TV to be watched within a preset time period) over time, the process is similar to that of a pay-per-view direct transaction, except that the rental package item is picked up from the rental zone and rules are checked to determine if a time window has expired and/or if the watch limit has not been exceeded. If a limit or expiration has been reached, a message is provided to the user with an option to re-buy the package.

According to various exemplary embodiments, a user may wish to earn credit tokens (e.g., ZillionDollars) by watching ad supported television, or performing other interaction with the service. For example, the user may turn on the television or select a program from the user interface of the client device. The content is played with ads placed according to a user's profile and preferences. An ad is watched. An on-screen indicator of accumulating credit tokens increases. After each ad has finished, the credit tokens are credited to the user's account. If the content is not finished playing, the user is returned to a program playlist to watch the next ad or continue watching the current program through the display device. If the content is finished playing, the user may rate the content using 1-5 stars. Then, the user is returned to the user interface of the client device.

In various embodiments, if a user wishes to purchase direct merchandise, then a user may indicate this to the system by pressing a button, such as a “BUY NOW” button on the client device. The content that the user was watching on the display device is paused and an offer page appears. The user may select a product from the offer page, and select a payment method (e.g., credit card funds, credit tokens, and the like). The user then confirms the charges and agrees to pay for the purchase. A transaction is performed with the help of a payment gateway if the payment gateway provides an authorization (AUTH) to the transaction manager to verify that the card holder is in good standing. If a product is shipped or delivered to the user, a CAPTURE request is provided to the payment gateway upon delivery of the product to request a transfer of funds from a bank or merchant. The display device then will show a purchase success screen to the user. An email is later sent to confirm a shipment of the purchased good. At any time, the user may cancel the transaction, and may then be returned to his original program. If he chooses to follow through with the transaction, he is returned to the program once he is provided with the purchase success screen.

In other embodiments, if the user wishes to gift content to another user, the methodology is similar to when a user purchases direct merchandise. After the offer page appears, the gifting user selects the gift option. The gifting user selects the recipient of the gift, and then the display device displays a confirmation from the gifting user. The gifting user selects the payment method, and also confirms the charges that he agrees to pay. The gift recipient can then use the gift to purchase content on the system. The system also will prompt the gift recipient to send an email of thanks to the gifting user.

According to further embodiments, if a user wishes to make a purchase from a merchandise mall, the methodology is similar to when a user purchases direct merchandise, with one notable exception. A third party product must be shipped for a CAPTURE request to be provided to the payment gateway upon delivery of the product.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. A computer implemented method for providing a response to a request, comprising:
receiving the request from a client device coupled to a display device, the client device being associated to a user;
determining whether the request is authorized;
transmitting the request to a server coupled to the display device; and
transmitting a response from the server to the display device for display therein, the response being based on the determination of whether the request is authorized.

2. The computer implemented method of claim 1, wherein the request includes a key if the request is authorized, the key associated with user data that is stored offsite by a data storage.

3. The computer implemented method of claim 1, wherein the display device includes a television set.

4. The computer implemented method of claim 2, further comprising:
generating the key if the request is authorized; and
associating the authorized request with the key.

5. The computer implemented method of claim 1, wherein the request is for a transaction.

6. The computer implemented method of claim 1, wherein the server is coupled to a payment processor, the payment processor configured to process payment transactions.

7. The computer implemented method of claim 1, wherein the server is coupled to a transaction manager, the transaction manager configured to manage a currency-based transaction based on the request.

8. The computer implemented method of claim 5, wherein the transaction is currency-based and is related to a purchase of a good, a service, and any combination thereof.

9. The computer implemented method of claim 2, wherein the user data includes sensitive credit card information associated with a credit card account of the user.

10. The computer implemented method of claim 2, wherein the user data includes banking account information associated with a banking account of the user.

11. The computer implemented method of claim 2, wherein a provider of the data storage for storing the sensitive credit card user data offsite comprises a merchant bank.

12. The computer implemented method of claim 1, wherein the response to be displayed on the display device includes one of a pay-per-view video, a video rental, a video purchase, a multimedia stream, a multimedia replay, a multimedia clip, a video stream, a video, a video replay, a video playback, a video clip, an audio stream, an audio replay, an audio clip, and any combination thereof.

13. The computer implemented method of claim 1, wherein the response includes an acknowledgment of the request if the request is authorized.

14. The computer implemented method of claim 1, wherein the response includes a denial of the request if the request is not authorized.

15. The computer implemented method of claim 1, wherein the server includes a user profile associated with the user.

16. The computer implemented method of claim 15, wherein the user profile includes a spending allocation for one or more user accounts.

17. The computer implemented method of claim 9, further comprising:
determining whether the user has reached a transaction threshold; and
transmitting a charge against the credit card account of the user if the transaction threshold has been reached.

18. The computer implemented method of claim 10, further comprising:
determining whether the user has reached a transaction threshold; and
transmitting a charge against the banking account of the user if the transaction threshold has been reached.

19. The computer implemented method of claim 17, further comprising receiving an electronic transfer of currency as a result of the charge against the credit card account of the user.

20. The computer implemented method of claim 18, further comprising receiving an electronic transfer of currency as a result of the charge against the banking account of the user.

21. The computer implemented method of claim 1, further comprising receiving a rating from the client device coupled to the display device, the rating being associated with the response from the server as displayed on the display device.

22. The computer implemented method of claim 5, wherein the request is for a transaction involving a quantity of credit tokens.

23. The computer implemented method of claim 1, further comprising transmitting an indicator of a media locker to the display device for display therein, the media locker representing a storage in a user account of a plurality of videos that the user has purchased.

24. A computer readable storage medium having stored thereon a program executable by a processor to perform a method for providing a response to a request, the method comprising:
receiving the request from a client device coupled to a display device, the client device being associated to a user;
determining whether the request is authorized;
transmitting the request to a server coupled to the display device; and
transmitting a response from the server to the display device for display therein, the response being based on the determination of whether the request is authorized.

25. The computer readable storage medium of claim 24, wherein the request includes a key if the request is authorized, the key associated with user data that is stored offsite by a data storage.

26. The computer readable storage medium of claim 24, wherein the display device includes a television set.

27. The computer readable storage medium of claim 24, wherein the method further comprises:
generating the key if the request is authorized; and
associating the authorized request with the key.

28. The computer readable storage medium of claim 24, wherein the request is for one of a currency-based transaction, a transaction involving a quantity of credit tokens, and any combination thereof.

29. The computer readable storage medium of claim 24, wherein the server is coupled to a payment processor, the payment processor configured to process payment transactions.

30. The computer readable storage medium of claim 24, wherein the server is coupled to a transaction manager, the transaction manager configured to manage a transaction based on the request.

31. The computer readable storage medium of claim 24, wherein the request is related to a purchase of a good, a service, and any combination thereof.

32. The computer readable storage medium of claim 25, wherein the user data includes information associated with a credit card account of the user.

33. The computer readable storage medium of claim 25, wherein the user data includes banking account information associated with a banking account of the user.

34. The computer readable storage medium of claim 24, wherein the response to be displayed on the display device includes one of a pay-per-view video, a video rental, a video purchase, a multimedia stream, a multimedia replay, a multimedia clip, a video stream, a video, a video replay, a video playback, a video clip, an audio stream, an audio replay, an audio clip, and any combination thereof.

35. The computer readable storage medium of claim 25, the method further comprising:
determining whether the user has reached a transaction threshold; and
transmitting a charge against the credit card account of the user if the transaction threshold has been reached.

36. The computer readable storage medium of claim 25, the method further comprising:
determining whether the user has reached a transaction threshold; and
transmitting a charge against the banking account of the user if the transaction threshold has been reached.

37. The computer readable storage medium of claim 34, the method further comprising receiving an electronic transfer of currency as a result of the charge against the credit card account of the user.

38. The computer readable storage medium of claim 35, the method further comprising receiving an electronic transfer of currency as a result of the charge against the banking account of the user.

39. The computer readable storage medium of claim 24, the method further comprising receiving a rating from the client device coupled to the display device, the rating being associated with the response from the server as displayed on the display device.

40. The computer readable storage medium of claim 24, the method further comprising transmitting an indicator of a media locker to the display device for display therein, the media locker representing a storage in a user account of a plurality of videos that the user has purchased.

41. A computer implemented method for providing a response to a request, comprising:
receiving the request from a client device coupled to a display device, the client device being associated to a user;
generating a key if the request is authorized, the key being associated with the user data stored offsite by a data storage;
associating the request with the key if the request is authorized;
determining whether the request includes the key;
transmitting the request to a server coupled to the display device; and
transmitting a response from the server to the display device for display therein, the response being based on the determination of whether the request includes the key.
